(19) United States
(12) Patent Application Publication
(10) Pub. No.: US 2026/0366173 A1
(43) Pub. Date: Nov. 19, 2026

(54) METHOD FOR PRODUCING AN ELECTROCHEMICAL CELL, ELECTROCHEMICAL CELL, FUEL CELL STACK AND ELECTROLYZER

(71) Applicant: Robert Bosch GmbH, Stuttgart (DE)

(72) Inventors: Li Wang, Tilburg (NL); Jan Willem Lenderink, Tilburg (NL); Joost Schnackers, Meerlen (NL); Walter Goorts, Veghel (NL)

(21) Appl. No.: 19/148,357

(22) PCT Filed: Jan. 16, 2024
(86) PCT No.: PCT/EP2024/050855

§ 371 Date: Jul. 16, 2025

(30) Foreign Application Priority Data
Jan. 16, 2023 (DE) 10 2023 200 282.5

(51) Int. Cl. C25B 9/23; C25B 1/04; C25B 9/77; C25B 11/032; C25B 11/081; H01M 8/0232; H01M 8/0245; H01M 8/1004; H01M 8/241

(52) U.S. Cl. CPC C25B 9/23; C25B 1/04; C25B 9/77; C25B 11/032; C25B 11/081; H01M 8/0232; H01M 8/0245; H01M 8/1004; H01M 8/241

(57) ABSTRACT

The invention relates to a method for producing an electrochemical cell (1), in particular a fuel cell or an electrolytic cell, in which method a membrane (2) is coated with a catalyst material (3) on both sides in order to form a cathode (2.1) and an anode (2.2), and a gas-transport and/or fluid-transport layer (4) is applied to both sides of the coated membrane (2). According to the invention, a nanoscale structure (5) made of an electrically conductive material is formed on at least one of the two gas-transport and/or fluid-transport layers (4) prior to them being applied to the membrane (2), and, while being applied, the gas-transport and/or fluid-transport layer (4) is oriented in such a way that the nanoscale structure (5) rests against the coated membrane (2). The invention also relates to an electrochemical cell (1), in particular a fuel cell or an electrolytic cell, and to a fuel cell stack and an electrolyzer each having at least one electrochemical cell (1) according to the invention.

### BACKGROUND

The invention relates to a method for producing an electrochemical cell, for example a fuel cell or an electrolytic cell.

Moreover, the invention relates to an electrochemical cell, in particular to a fuel cell or an electrolytic cell. Furthermore, a fuel cell stack and an electrolyzer are indicated, each having at least one electrolytic cell according to the present invention.

The electrolyzer may in particular be a PEM electrolyzer for producing hydrogen.

An electrochemical cell has a multi-coated or multi-layered construction. A central coating or layer forms a membrane, which is coated on both sides with a catalyst material, so that on one side a cathode and on the other side an anode are formed. This arrangement is also referred to as a membrane-electrode (MEA) arrangement. The MEA is bound by a gas-transport and/or fluid-transport layer as well as a bipolar plate on each side, wherein the bipolar plates are the outward termination of the cell. The bipolar plate typically serves as an embossed sheet that forms a flow field at the plate level for a medium needed for the electrochemical reaction in the cell. The respective medium then reaches the membrane, that is, the area in which the electrochemical reaction takes place, via the gas-transport and/or fluid-transport layers resting against the bipolar plates. The gas-transport and/or fluid-transport layers each have a porous structure for media transport purposes.

To apply and/or tap into an electrical voltage, the gas-transport and/or fluid-transport layers must also be in electrical contact with the membrane. To optimize the electrical contact, the gas-transport and/or fluid-transport layers may each comprise a microporous layer on the membrane side. Gas and/or liquid transport layers are also known, each of which is coated with a catalyst material in place of the membrane, and thus form part of the MEA.

Various catalyst materials are known in the prior art. Platinum (Pt), iridium (Ir), ruthenium (Ru) and osmium (Os) as well as compounds thereof, for example PtOₓ, IrO₂, IrOₓ, Ru, RuO₂, RuOₓ, OsOₓ, are often employed as catalyst material. To form a catalyst layer on a membrane or gas-transport and/or fluid-transport layer, particles of the respective catalyst material are mixed with a binder, in particular an ionomer, and the mixture is applied to the respective surface to be coated.

The degree of loading of a catalyst layer with catalyst material significantly affects the efficiency of an electrochemical cell. However, with increased degree of loading, the costs are also increasing. The interest is therefore great to lower the degree of loading, but without compromising the functionality of the cell.

### SUMMARY

This problem is addressed by the present invention. To solve the problem, the method and the electrochemical cell with the features of the disclosure are proposed.

Furthermore, a fuel cell stack and an electrolyzer are each indicated with at least one electrochemical cell according to the present invention.

A method for producing an electrochemical cell, in particular a fuel cell or an electrolytic cell, is proposed. In the method, a membrane for forming a cathode and an anode is coated on both sides with a catalyst material and a gas-transport and/or fluid-transport layer is applied on both sides to the coated membrane. According to the invention, a nanoscale structure made of an electrically conductive material is formed on at least one of the two gas-transport and/or fluid-transport layers prior to them being applied to the membrane, and, while being applied, the gas-transport and/or fluid-transport layer is oriented in such a way that the nanoscale structure rests against the coated membrane.

The nanoscale structure on the gas-transport and/or fluid-transport layer increases the roughness of the surface resting against the membrane and thus the contact surface. This means the average path length of electrons flowing from the gas-transport and/or fluid-transport to the membrane is shortened and the efficiency of the cell is increased. This in turn allows the degree of loading of a catalyst layer with catalyst material to lower.

To form the nanoscale structure, preferably an electrically conductive material is used, which has a very high electrical conductivity and is also chemically stable. Gold, platinum, iridium, a platinum alloy or an iridium alloy is therefore preferred as the electrically conductive material.

Furthermore, preferably, to form the nanoscale structure, the electrically conductive material is squirted or sprayed onto the at least one gas-transport and/or fluid-transport layer. Methods such as sputtering are particularly suitable for this purpose. When spraying or squirting, the electrically conductive material may be finely atomized such that individual particles, hair-like or fiber-like structures form the desired nanoscale structure. In this case, further work steps for forming the nanoscale structure are not required.

Alternatively, the electrically conductive material may be applied in a complete and/or opaque manner on the at least one gas-transport and/or fluid-transport layer and may be partially removed after application to form the desired nanoscale structure. The partial removal of the electrically conductive material may be effected, for example by laser ablation.

In further development of the invention it is proposed that the at least one gas-transport and/or fluid-transport layer be coated with platinum prior to application of the electrically conductive material. The bonding of the electrically conductive material to the gas-transport and/or fluid-transport layer can be improved via the intermediate layer of platinum. Coating the gas-transport and/or fluid-transport layer with platinum may be effected, for example by physical vapor deposition, electrochemical deposition or atomic layer deposition.

To the extent that a nanoscale structure is only formed on one gas-transport and/or fluid-transport layer, this is preferably the anode-side gas-transport and/or fluid-transport layer. This is particularly true when the electrochemical cell is an electrolytic cell for generating hydrogen. This is because in this case, the anode-side catalyst layer typically comprises iridium as a catalyst material, which is very rare and at the same time very expensive. The nanoscale structure on the gas and/or liquid transporting layer thus helps to conserve iridium without compromising the functionality of the cell.

Furthermore, it is proposed that the nanoscale structure is formed in the area of a microporous layer of the at least one gas-transport and/or fluid-transport layer. This means that a gas-transport and/or fluid-transport layer with a microporous layer is used. This then serves as an intermediary between the porous structure of the gas-transport and/or fluid-transport layer and the nanoscale structure. If the bonding is to be improved by means of an intermediate layer of platinum, the microporous layer of the gas-transport and/or fluid-transport layer is coated with platinum.

In addition, an electrochemical cell, in particular a fuel cell or an electrolytic cell, is proposed. The electrochemical cell comprises a membrane that is coated on each side with a catalyst material to form a cathode and an anode on both sides. The coated membrane is arranged between two gas-transport and/or fluid-transport layers. According to the invention, a nano-scale structure is formed from an electrically conductive material on at least one gas-transport and/or fluid-transport layer, via which the gas-transport and/or fluid-transport layer is in electrically conductive contact with the coated membrane.

The nanoscale structure formed on the at least one gas-transport and/or fluid-transport layer increases the roughness of the surface, and thus the contact surface of the gas-transport and/or fluid-transport layer with the coated membrane. Accordingly, it improves the electron flow from the gas-transport and/or fluid-transport layer to the coated membrane. As a result, the efficiency of the cell can be increased. At the same time, the degree of loading of the catalyst layer applied to the membrane with catalyst material may be reduced so as to conserve catalyst material.

To the extent that a nanoscale structure is only formed on one gas-transport and/or fluid-transport layer, it is preferably the anode-side gas-transport and/or fluid-transport layer, and this is particularly the case if the electrochemical cell is an electrolytic cell for generating hydrogen. This is because in this case iridium serving as a catalyst material can be saved, which is very rare and therefore very expensive.

The proposed electrochemical cell may in particular have been produced with a method according to the invention, so, in this respect, reference is made to the method description above.

Advantageously, the electrically conductive material forming the nanoscale structure is gold, platinum, iridium, a platinum alloy, or an iridium alloy, as these materials have a very high electrical conductivity and are also chemically stable.

Preferably, the nanoscale structure is formed on a microporous layer of the at least one gas-transport and/or fluid-transport layer. The microporous layer serves as an intermediary between the porous structure of the gas-transport and/or fluid-transport layer and the nanoscale structure.

Alternatively, or in addition, it is proposed that the nanoscale structure be formed on a platinum coating of the at least one gas-transport and/or fluid-transport layer. The platinum layer improves the bonding of the electrically conductive material to the gas-transport and/or fluid-transport layer. To the extent that the gas-transport and/or fluid-transport layer comprises a microporous layer, it is coated with platinum.

Since the electrochemical cell can be particularly useful in a fuel cell stack, a fuel cell stack having at least one electrochemical cell according to the present invention is further proposed. Preferably, a plurality of, further preferably all electrochemical, cells of the fuel cell stack are arranged according to the invention. In this way, an increase in efficiency of the fuel cell stack can be achieved that also helps conserve catalyst material.

In the fuel cell stack, clamping forces act upon the at least one electrochemical cell according to the invention, which forces are typically applied by means of bolts for clamping together the electrochemical cells. The individual coatings or layers of the electrochemical cell according to the invention are clamped together by means of the clamping forces. The nanoscale structure applied to at least one gas-transport and/or fluid-transport layer is thereby pressed into the catalyst layer of the adjacent membrane so that individual particles, hairs and/or fibers of the nanoscale structure penetrate into the catalyst layer. In this way, the contact surface between the gas and/or the liquid transport layer and the membrane can be increased again so that the positive effects described above are even more pronounced.

Since the electrochemical cell according to the invention can also be used in an electrolyzer, an electrolyzer with at least one electrochemical cell according to the invention is further proposed. The electrolyzer may in particular be a PEM electrolyzer for producing hydrogen. In that case, iridium, which is typically employed in an electrolytic cell as a catalyst material of an anode-side catalyst layer to generate hydrogen, may especially be conserved.

Since electrochemical cells are also clamped together in an electrolyzer, the clamping forces here cause individual particles, hair and/or fibers of the nanoscale structure formed on at least one gas-transport and/or fluid-transport layer to penetrate into the catalyst layer and thereby further increase the contact surface between the gas-transport and/or fluid-transport layer and the membrane.

### BRIEF DESCRIPTION OF THE DRAWINGS

The invention and the advantages thereof are explained in more detail below with reference to the accompanying drawings. They show:

FIG. 1 a schematic longitudinal section through a conventional electrochemical cell,

FIG. 2 a schematic longitudinal section through a further conventional electrochemical cell,

FIG. 3 a schematic longitudinal section through an electrochemical cell according to the invention,

FIG. 4 an enlarged section of FIG. 3 in the area of the gas-transport and/or fluid-transport layer, and

FIG. 5 a perspective representation of a cell stack for forming a fuel cell stack or an electrolyzer.

### DETAILED DESCRIPTION

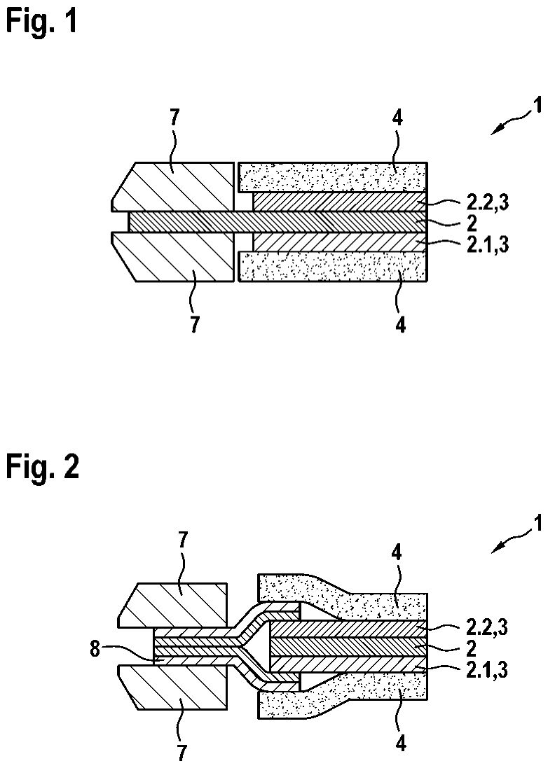

Based on FIGS. 1 and 2, the construction of a conventional electrochemical cell 1 is first explained.

The electrochemical cell 1 shown in FIG. 1 comprises a centrally arranged membrane 2, which is coated with a catalyst material 3 on both sides to form a cathode 2.1 and an anode 2.2. Different catalyst materials 3 can be used on the anode side and on the cathode side. On both sides, a gas-transport and/or fluid-transport layer 4 rests against the coated membrane 2, which has a porous structure, so that the media required for the electrochemical reaction in cell 1 reach the coated membrane 2 through this structure. The membrane 2 is designed with a larger surface than the gas-transport and/or fluid-transport layers 4, wherein the protruding edge area is clamped between two electrically conductive components, for example between two bipolar plates 7. The two bipolar plates 7 are electrically isolated from each other via the membrane 2.

The electrochemical cell 1 shown in FIG. 2 has a modified construction. Here, the membrane 2 does not have any protruding edge region. The electrical isolation is effected here by means of a gasket 8, which surrounds the coated membrane 2 on the edge and is glued to the membrane 2 such that it is impermeable to fluids.

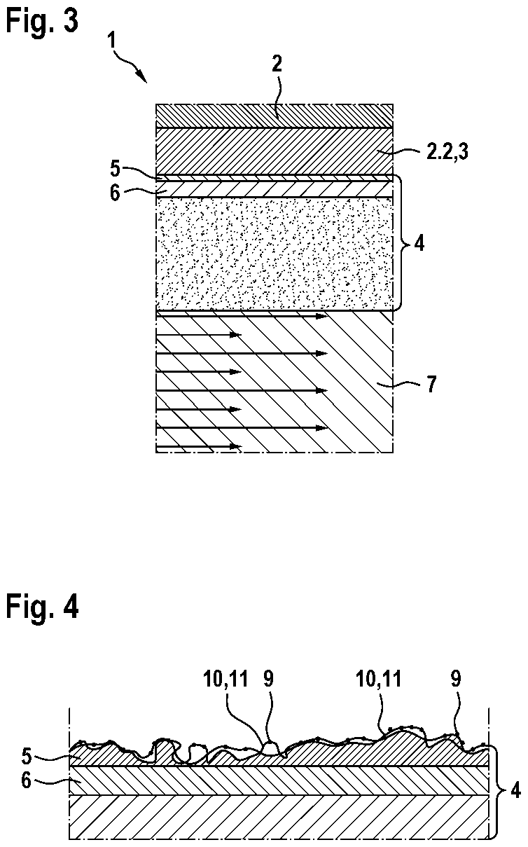

The gas-transport and/or fluid-transport layers 4 of an electrochemical cell 1 may comprise a microporous layer 6 on the membrane side. Thus, the electrochemical cell 1 according to the invention, is exemplified in FIG. 3, wherein FIG. 3 only shows the anode-side construction of the cell 1. The membrane 2 is coated on the anode side with a catalyst material 3, so that a catalyst layer is formed which the anode-side gas-transport and/or fluid-transport layer 4 rests against. In the present case, this not only comprises a microporous layer 6 on the side facing the membrane 2, but also a nanoscale structure 5 made of an electrically conductive material. This contacts the catalyst layer applied to the membrane 2, wherein the nanoscale structure 5 simultaneously causes an enlargement of the contact surface.

As can in particular be seen in FIG. 4, the nanoscale structure 5 forms protruding particles 9, hairs 10, and/or fibers 11, which reach to the catalyst layer of the membrane 2. If a plurality of electrochemical cells 1 is connected to a cell stack 12 and clamped together, these particles 9, hairs 10, and/or fibers 11 penetrate the catalyst layer so that the contact surface of the gas-transport and/or fluid-transport layer 4 with the membrane 2 is increased again.

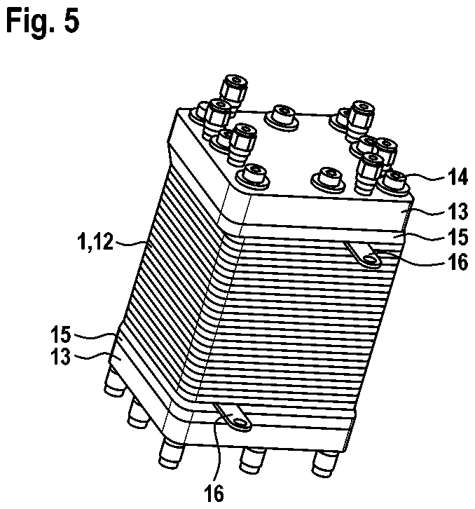

FIG. 5 shows an exemplary cell stack 12 consisting of a plurality of electrochemical cells 1 arranged between two end plates 13. Between the end plates 13 and the cell stack 12, power collector plates 16 as well as further plates 15 are arranged for electrical isolation. The arrangement is clamped together with the aid of bolts 14. This means that both the electrochemical cells 1 and the coatings or layers of each individual electrochemical cell 1 are clamped together. If the electrochemical cell 1 comprises a gas-transport and/or fluid-transport layer 4 with a nanoscale structure 5, it penetrates the adjacent catalyst layer of the membrane 2 via the protruding particles 9, hairs 10 and/or fibers 11, such that the contact surface between the gas-transport and/or fluid-transport layer 4 and the membrane 2 is increased again and/or the catalyst layer applied thereon is enlarged.

1. A method for producing an electrochemical cell (1), in which method a membrane (2) is coated with a catalyst material (3) on both sides to form a cathode (2.1) and an anode (2.2), and a gas-transport and/or fluid-transport layer (4) is applied to both sides of the coated membrane (2),
wherein a nanoscale structure (5) made of an electrically conductive material is formed on at least one of the gas-transport and/or fluid-transport layers (4) prior to them being applied to the membrane (2), and, while being applied, the gas-transport and/or fluid-transport layer (4) is oriented in such a way that the nanoscale structure (5) rests against the coated membrane (2).

2. The method according to claim 1,
wherein gold, platinum, iridium, a platinum alloy or an iridium alloy is used as the electrically conductive material.

3. The method according to claim 1,
wherein the electrically conductive material is sprayed or squirted onto the gas-transport and/or fluid-transport layer.

4. The method according to claim 1,
wherein the electrically conductive material is applied to the gas-transport and/or fluid-transport layer in a complete and/or opaque manner and is partially removed after application.

5. The method according to claim 1,
wherein the gas-transport and/or fluid-transport layer (4) is coated with platinum prior to application of the electrically conductive material.

6. The method according to claim 1,
wherein the nanoscale structure (5) is formed on an anode-side gas-transport and/or fluid-transport layer (4).

7. The method according to claim 1,
wherein the nanoscale structure (5) is formed in an area of a microporous layer (6) of the gas-transport and/or fluid-transport layer (4).

8. An electrochemical cell (1) comprising a membrane (2) that is coated with a catalyst material (3) on both sides to form a cathode (2.1) and an anode (2.2), wherein the coated membrane (2) is arranged between two gas-transport and/or fluid-transport layers (4),
wherein a nanoscale structure (5) is formed from an electrically conductive material on at least one gas-transport and/or fluid-transport layer (4), via which the gas-transport and/or fluid-transport layer (4) is in electrically conductive contact with the coated membrane (2).

9. The electrochemical cell (1) according to claim 8,
wherein the electrically conductive material is gold, platinum, iridium, a platinum alloy, or an iridium alloy.

10. The electrochemical cell (1) according to claim 8,
wherein the nanoscale structure (5) is formed on a microporous layer (6) and/or a platinum coating of the at least one gas-transport and/or fluid-transport layer (4).

11. A fuel cell stack having at least one electrochemical cell (1) according to claim 8.

12. An electrolyzer having at least one electrochemical cell (1) according to claim 8.

13. The method according to claim 1, wherein the electrochemical cell (1) is a fuel cell or an electrolytic cell.

14. The method according to claim 4, wherein the electrically conductive material is partially removed after application by laser ablation.

15. The method according to claim 5, wherein the gas-transport and/or fluid-transport layer (4) is coated with platinum by physical vapor deposition, electrochemical deposition or atomic layer deposition.

16. The electrochemical cell (1) according to claim 8, wherein the electrochemical cell (1) is a fuel cell or an electrolytic cell.

17. The electrolyzer according to claim 12, wherein the electrolyzer is a PEM electrolyzer for the production of hydrogen.
